(19) United States
(12) Patent Application Publication
(10) Pub. No.: US 2005/0283511 A1
(43) Pub. Date: Dec. 22, 2005

(54) Cross-feature analysis

(76) Inventors: Wei Fan, New York, NY (US); Philip Shi-Iung Yu, Chappaqua, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(21) Appl. No.: 10/658,623

(22) Filed: Sep. 9, 2003

(51) Int. Cl. G06F 7/38; G06F 15/173

(52) U.S. Cl. 708/306; 708/307; 708/321; 709/226

(57) ABSTRACT

Disclosed is a method of automatically identifying anomalous situations during computerized system operations that records actions performed by the computerized system as features in a history file, automatically creates a model for each feature only from normal data in the history file, performs training by calculating anomaly scores of the features, establishes a threshold to evaluate whether features are abnormal, automatically identifies abnormal actions of the computerized system based on the anomaly scores and said threshold, and periodically repeats the training process.

### BACKGROUND OF THE INVENTION

1. Field of the Invention

The present invention generally relates to automatically identifying anomalous situations during computerized system operations and more particularly to a system that creates a model for each feature only from historical normal data.

2. Description of the Related Art

To achieve the goal of autonomic computing, it is important for the target system to be able to perform self-diagnosis i.e., detecting tracking and recording anomalous situations during system operations. Almost all existing solutions are expert-based systems that use human knowledge to track the deviation from normal behaviors. There are several known problems with the manual approach. First, the system is limited to the knowledge and experiences of the experts. In many applications of diagnostic systems, automated systems have been shown to greatly outperform the best human systems. The second problem is that the development cycle is lengthy and slow. The resultant system may already be a legacy by the time it is deployed since patterns of anomaly do change and may not be detected by the experts. The invention provides an accurate and efficient solution to self-diagnosis in autonomic computing.

The below references disclose embodiments that were satisfactory for the purposes for which they were intended. The disclosures of the below-references, in their entireties, are hereby expressly incorporated by reference into the present invention for purposes including, but not limited to, indicating the background of the present invention and illustrating the state of the art. W. W. Cohen. Fast effective rule induction, In Machine Learning: the 12th International Conference, Lake Taho, Calif., 1995 (hereinafter referred to as Cohen). E. Osuna, R. Freund, and F. Girosi. Support vector machines: Training and applications, Technical Report AIM-1602, Massachusetts Institute of Technology AI Lab, 1997 (hereinafter referred to as Osuna et al.). J. R. Quinlan. C4.5: Programs for machine learning, San Mateo, Calif., 1993 (hereinafter referred to as Quinlan).

### SUMMARY OF THE INVENTION

The invention provides a method of automatically identifying anomalous situations during computerized system operations. The invention begins with historical data (possibly maintain in a history file). The invention then automatically creates a model for each feature only from normal data in the history file.

More specifically, in order to create the models for the features, the invention establishes relationships that exist between the features for normal computerized system operations (from the history file). Then, the invention selects a labeled feature from the features and mathematically rearranges the relationships from the point of view of the labeled feature to create a solution for the labeled feature. This “solution” is the model for that labeled feature. The solution comprises a mathematical statement of what the labeled feature equals in terms of the relationships between the remaining features. The invention also selects different features as the labeled feature and repeats the process of mathematically rearranging the relationships to produce solutions from the point of view of each remaining feature (as models for those remaining features).

After so creating the models, the invention then performs training by calculating anomaly scores of the features. More specifically, the invention predicts the likelihood that each feature will be normal when one or more of the other features are abnormal, using the models. This process is repeated using different presumptions about other features being normal and abnormal to produce a trained file of a plurality of normality and anomaly scores for each of the features. The trained file thus provides an anomaly score for each of the features for each of a plurality of different possible abnormalities. The training process can be periodically repeated.

The invention also establishes a threshold to evaluate whether features are abnormal. The invention automatically identifies abnormal actions of the computerized system based on the anomaly scores and the threshold. More specifically, the invention determines the values of the features for a given operation of the computerized system. With this information, the invention refers to the trained file to retrieve an anomaly score for each of the features and then compares the anomaly score for each of the features with the threshold to determine whether each anomaly score exceeds the threshold.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating a preferred method of the invention;

FIG. 2 is a table illustrating normal events in the 2-node network example;

FIGS. 3A-3C are tables illustrating cross-feature models;

FIG. 4 is a table illustrating the outcome from normal and abnormal events;

FIG. 5 is a table illustrating recall-precision curves using average probability.

### DETAILED DESCRIPTION OF PREFERRED EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention in detail. The following examples are intended merely to facilitate an understanding of ways in which the invention may be practiced and to further enable those of skill in the art to practice the invention. Accordingly, the examples should not be construed as limiting the scope of the invention.

The invention provides a general solution to the conventional problems associated with self-diagnosis in autonomic computer cross-feature analysis using a fully automatic generic data mining method that applies the inter-feature correlation to detect deviation from established or normal behavior. In its most generic form, the invention provides cumulative evidence of threshold-based anomaly detection. More specifically, the invention uses an additive methodology to combine the evidences (operations, features) from multiple sources, and then uses a probabilistic thresholding approach to detect anomalies.

More specifically, the invention utilizes cross-feature evidence accumulation. The invention provides specific methods and frameworks to convert a data set of one single label, such as normal or established behavior, into multiple cross-feature predictors. The cross-feature predictor is a model to predict the value of the chosen feature from multiple disjoint feature sets. The output of a cross-feature predictor is used as evidence against a labeled instance. The evidences from multiple cross-feature predictors are then combined to perform the threshold-based anomaly detection.

One problem with multiple evidences is that some multiple sources may be correlated to some degree. Therefore, the use of multiple source evidences' may slow down real time detection. The following describes an approach to use empirically-based correlation analysis to reduce the total number of evidences' to improve system throughput.

One example of the invention is described below. Assuming that there is a dataset of N features. In order to detect anomalies, the invention converts the problem into N models. Each model is a function to map N-1 features to I remaining feature, such that model C_i: f_{—}1, f_{—}2 f_i-1, f_+!, f_N→f_i. Each model predicts the value of one feature from the other features. When training completes, there are N models. When a new data item comes in, the invention applies all N models on the data item. The invention compares the difference of the predicted feature value to its true value. The difference from all features is accumulated. When the accumulated difference is bigger than a threshold, the new data item is classified as an anomaly.

Advantages of the invention include that the method is a general framework that is applicable to a wide variety of inductive learning methodology, such as decision tree, rule learner, probabilistic modeling among others. There is no assumption about the form of the methodology. Another advantage is that the process is fully automated with minimum help from users. Besides autonomic computing, the invention can be used as a general toolset for anomaly detection in a wide range of areas. On the other hand, existing solutions are application-specific, domain-specific, not fully automated, slow to develop, and inaccurate.

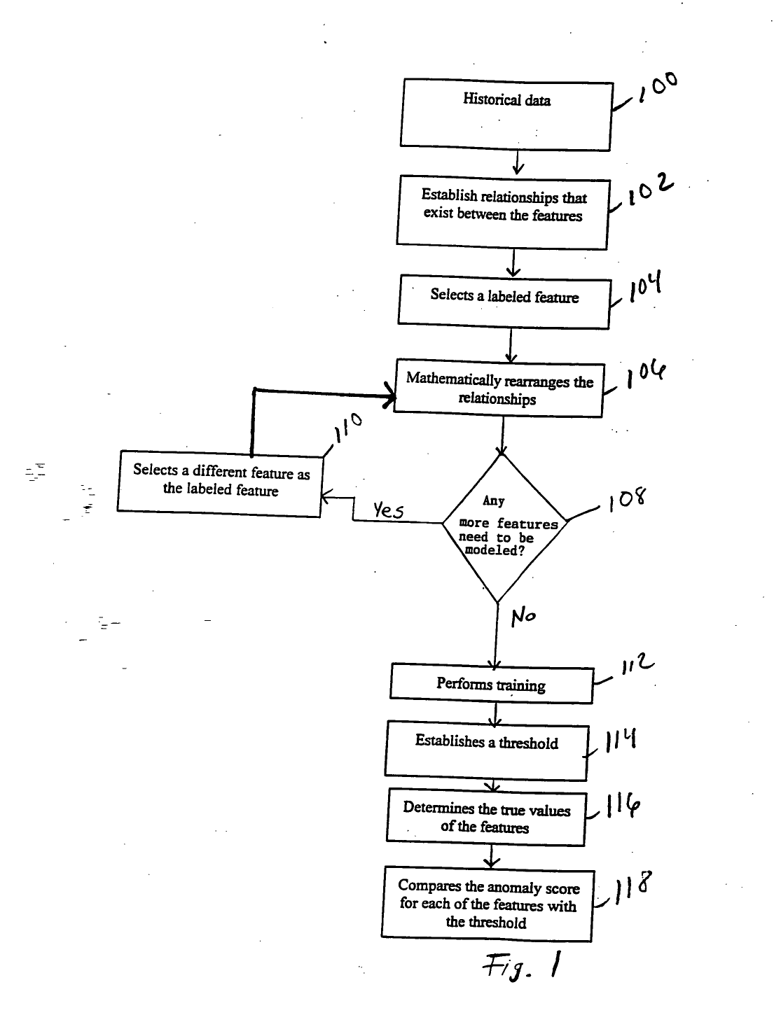

The invention is summarized in the flowchart shown in FIG. 1. Therefore, the flowchart shown in FIG. 1 generalizes the inventive method of automatically identifying anomalous situations during computerized system operations. The invention begins with historical data 100 (possibly maintain in a history file). The invention then automatically creates a model for each feature only from normal data in the history file.

More specifically, in order to create the models for the features, the invention establishes relationships that exist between the features 102 for normal computerized system operations (from the history file). Then, the invention selects a labeled feature 104 from the features and mathematically rearranges the relationships 106 from the point of view of the labeled feature to create a solution for the labeled feature. This “solution” is the model for that labeled feature. The solution comprises a mathematical statement of what the labeled feature equals in terms of the relationships between the remaining features. The invention checks whether there are any more features that need to be modeled 108. If so, the invention selects a different feature as the labeled feature 110 and repeats the process (shown by the loop in FIG. 1) of mathematically rearranging the relationships to produce solutions from the point of view of each remaining feature (as models for those remaining features).

After so creating the models, the invention then performs training 112 by calculating anomaly scores of the features. More specifically, the invention predicts the likelihood that each feature will be normal when one or more of the other features are abnormal, using the models. This process is repeated using different presumptions about other features being normal and abnormal to produce a trained file of a plurality of normality and anomaly scores for each of the features. The trained file thus provides an anomaly score for each of the features for each of a plurality of different possible abnormalities. The training process 112 can be periodically repeated.

The invention also establishes a threshold 116 to evaluate whether features are abnormal. The invention automatically identifies abnormal actions of the computerized system based on the anomaly scores and the threshold. More specifically, the invention determines the “true” values of the features for a given live operation of the computerized system 118. With this information, the invention refers to the trained file to retrieve and anomaly score for each of the features and then compares the anomaly score for each of the features with the threshold 120 to determine whether each anomaly score exceeds the threshold.

The basic idea of a cross-feature analysis framework is to explore the correlation between one feature and all the other features, i.e., try to solve the classification problem {f₁l, f₂, . . . ,fᵢ₋₁,fᵢ+₁, . . . ,f_{L}}→fᵢ where {f₁,f₂, . . . , f_{L}}is the feature vector. Note that in the machine learning area, the terminology class in a classification system represents the task to be learned based on a set of features, and the class labels are all possible values a class can take. In the domain of diagnosis and anomaly detection, one would most likely to learn the system healthy status (the class) from known system information (the features), and normal or abnormal are both possible class labels.

A basic assumption for anomaly detection is that normal and abnormal events should be able to separate from each other based on their corresponding feature vectors. In other words, given a feature vector, one should be able to tell whether the related event is normal or not, without ambiguity. This assumption is reasonable since otherwise the feature set is not sufficient and must be redefined. Under this assumption, the invention can name a feature vector related to a normal event a normal vector, for short. Similarly, a feature vector not related to any normal events an abnormal vector. Here, all feature values are discrete. However, as would be readily understood by one ordinarily skilled in the art in light of the specification, the invention is not limited to discrete features, but is useful with all forms of data, and discrete features are used herein to simplify the examples and aid in understanding.

Cross-feature analysis trains multiple classification and/or regression models to predict the known values of multiple features in the data entry. When the predicted values differ significantly from the true values, the example will be labeled as anomalous. Assuming that the feature vectors {f1, f2, . . . . . . , fn}, the cross-feature model C, to predict feature value f, is trained from {f2, F3, . . . . . . , fn}→{f1}. In other words the feature f is left out, in the dataset, and use the remaining features f2 to fn to train a model C, to predict the value of f1. This procedure is repeated from all features f1 to fn and we will have up to n models. Each cross-feature model Ci can be either a classification model or regression model. If fi is a discrete feature such as a gender, Ci is a classification model. On the other hand, when fi is a continuous variable such as income, Ci is usually trained as a regression model. Cross-feature analysis is a general procedure. Both classification and regression models are steps that are called by cross-feature analysis procedure. Cross-feature analysis is at the meta-level, while both classification and regression are at a sub-level. However, cross-feature analysis is not limited to use classification and regression models only as the submodels.

Both classification and regression models use particular heuristics and representations to compute a model. Their heuristics and representations are completely independent from cross-feature analysis. The only interface between cross-feature analysis and classification/regression model is to call these models with feature values and the models will return a prediction back.

For all normal vectors, the invention chooses one feature as the target to classify (which is called the labeled feature), and then computes a model using all normal vectors to predict the chosen target feature value based on remaining features. In other words, training a classification model Cᵢ{f₁, . . . , fᵢ₋₁, fᵢ+₁, . . . ,f_{L}}→{fᵢ}. For normal events, the prediction by Cᵢ is very likely to be the same as the true value of the feature; however, for anomalies, this prediction is likely to be different. The reason is that Cᵢ is trained from normal data, and their feature distribution and pattern are assumed to be different from those of anomalies. This implies that when normal vectors are tested against Cᵢ, it has a higher probability for the true and predicted values of fᵢ to match. Such probability is significantly lower for abnormal vectors. Therefore, by evaluating the degree of result matching, it is more likely to find the difference between normal and abnormal patterns. The model defined above is a sub-model with respect to fᵢ. Relying on one sub-model with respect to one labeled feature is insufficient as the correlation among other features has not yet been considered. Therefore, the model building process is repeated for every feature and up until L sub-models are trained. Once done, the first step has been accomplished of the cross-feature analysis approach, i.e. the training procedure, which is summarized in Methodology 1 below.
Data: feature vectors of training data f₁, . . . f_{L};
Result: classifiers C₁, . . . ,C_{L};
begin
   ∀i, train Cᵢ:{f₁, . . . ,fᵢ₋₁, fi₊₁ . . . ,f_{L}}→fᵢ;
   return C₁, . . . ,C_{L};
end

To generalize the framework to continuous features or discrete features with an infinite value space (e.g., the integer set), they cannot be used directly as class labels since only discrete (nominal) values are accepted in this example. Either discretizeing them based on frequency or using multiple linear regression is the next step. With multiple linear regression, the log distance is used,

$$\vert log ( \frac{Ci ( χ )}{fi ( χ )} ) \vert ,$$

to measure the difference between the prediction and the true value, where Cᵢ (x) is the predicted value from sub-model with respect to fᵢ.

Once all sub-models have been trained, the system event and status data are analyzed as follows. When an event is analyzed, the feature vector is applied to all sub-models, and a count is made of the number of models whose predictions match the true values of the labeled features. The count is then divided by L, so that the output, which is called the average match count, is normalized. All sub-models do not need to match. In fact, a decision threshold is used. An event is classified as an anomaly if and only if the average match count is below the threshold. Since it is hard to develop a perfect solution to determine the decision threshold for a general anomaly detection problem directly and in practice, a small value of false alarm rate is often allowed. The threshold is determined as follows: compute the average match count values on all normal events, and use a lower bound of output values with certain confidence level (which is one minus false alarm rate). As a summary, Methodology 2 lists the strawman version of the test procedure. For convenience, fi(x) denotes the value of feature fi belonging to event χ·[π] returns 1 if the predicate π is true.
Data: classifiers Cᵢ, . . . ,C_{L}, event χ=(f₁, . . . ,f_{L}), decision threshold θ;
Result: either normal or anomoly;
begin
   AvgMatchCount←Σᵢ[Ci(x)=fi(x)]L;
   if AvgMatchCount≧θ then return “normal”;
   else return “anomaly”;
end

To provide an improvement to the strawman Methodology the invention uses probability instead of the 0-1 count, the probability values for every possible class are available from most inductive learners (e.g., decision trees, induction rules, naive Bayes, etc.). This approach can improve detection accuracy since a sub-model should be preferred where the labeled feature has stronger confidence to appear in normal data. Methodology 2 can actually be regarded as a special case under the assumption that the predicted class is the only valid class and hence has a probability of 1.0, so the probability for the true class is either 1 (when the rule matches) or 0 (otherwise). More strictly, assume that p(fi(x)|x) is the estimated probability for the true class of the labeled feature, defining the average probability as the average output value of probabilities associated with true classes over all classifiers. The optimized version is shown in Methodology 3.
Data: classifiers C₁, . . . , C_{L}, event x=(f₁, . . . , f_{L}), decision threshold θ;
Result: either normal or anomaly;
begin
   AvgProbability←Σᵢp(fᵢ(x)|x)/L;
   if AvgProbability≧θ then return “normal”;
   else return “anomaly”;
end

The probability function can be calculated in some popular classification methodology, as described here in detail. Decision tree learners (such as Quinlan) uses a divide-and-conquer strategy to group examples with the same feature values until it reaches the leaves of the tree where it cannot distinguish the examples any further. Suppose that n is the total number of examples in a leaf node and nᵢ is the number of examples with class label lᵢ in the same leaf.

$$p ( {l}_{i} \vert x ) = \frac{{n}_{i}}{n}$$

is the probability that χ is an instance of class lᵢ. Probability is calculated in a similar way for decision rule classifiers, e.g. Cohen. For naive Bayes classifiers (one such implementation (NBC) is publicly available at http://fuzzy.cs.unimagdeburg.de/˜borgelt/software.html) assuming that aⱼ's are the feature values of x, p(lᵢ) is the prior probability or frequency of class lᵢ in the training data, and p(aⱼ|lᵢ) is the prior probability to observe feature attribute value aⱼ given class label lᵢ, then the score n(lᵢ|x) for class label lᵢ is: n(lᵢ|x)=p(lᵢ)Πⱼp(aⱼ|lᵢ) and the probability is calculated on the basis of

$$n ( {l}_{i} \vert x ) as p ( {l}_{i} \vert x ) = \frac{n ( {l}_{i} \vert x )}{{\sum }_{k} n ( {l}_{k} \vert x )} \cdot .$$

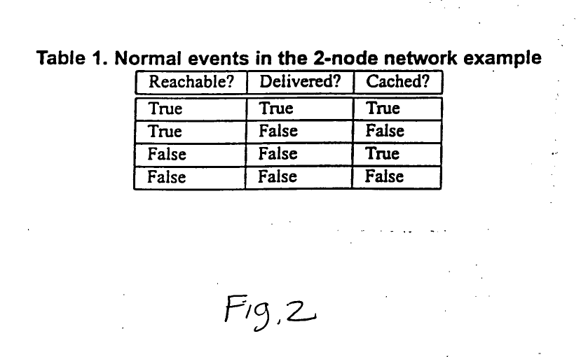

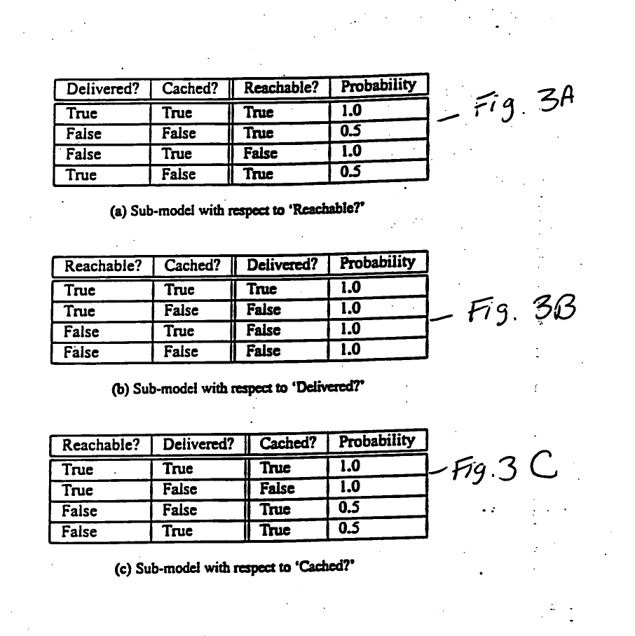

FIG. 2 is an illustrative example that has been simplified to demonstrate this framework. Consider an ad-hoc network organized by two nodes. Packets can only be delivered from one end to the other if they are within each other's transmission range. FIG. 2 illustrates three features. The first feature is the other node reachable? The second is, are there any packets delivered during last 5 seconds, and lastly, the third is, are there any packets cached for delivery during last 5 seconds? For simplicity, assume all features are binary valued, i.e., either True or False. All normal events are enumerated in FIG. 2. Then, by constructing three sub-models with respect to each feature, shown in FIGS. 3A-3C, the “probability” columns here denote the probability associated with predicted classes. FIGS. 3A-3C illustrate the results of the training process that the invention performs.

An illustrative classifier in this example works as follows. If only one class is seen in all normal events where other non-labeled features have been assigned with a particular set of values, the single class is selected as the predicted class with the associated probability of 1.0. If both classes are seen, label True is always selected with the associated probability of 0.5. If none are seen (which means the combination of the other two feature values never appears in normal data), then select the label which appears more in other rules, with the associated probability of 0.5. To compute the probability for the true class, the probability associated with the predicted class if it matches, or one minus the associated probability if it does not is used. For example, the situation when a route is viable, no data is cached and no data is therefore delivered is a normal case. Applying the corresponding feature vector, {True, False, False}, into all three sub-models and all match the predicted classes is illustrated. But the first sub-model with respect to the feature “Reachable?” has a probability of 0.5 only, since when no data is delivered, it does not matter whether the route is up or not. The average match count is then calculated as (1+1+1)/3=1, and the average probability is (1+1+0.5)/3=0:83. Suppose there is a threshold of 0.5, then both values tell that the event is normal, which is correct.

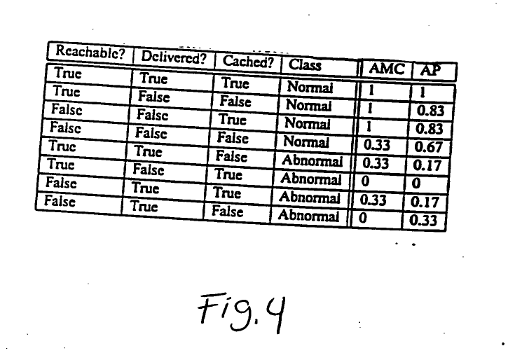

A complete list of the average match counts and average probabilities for all possible events (both normal and abnormal) is shown in FIG. 4. Note that abbreviations are used here where AMC stands for the Average match count, and AP is the Average probability. The results show that given a threshold of 0.5, both Methodology 2 and 3 work well to separate normal and abnormal events, while Methodology 3 works better as it achieves perfect accuracy (Methodology 2 has one false alarm with the input {False, False, False}).

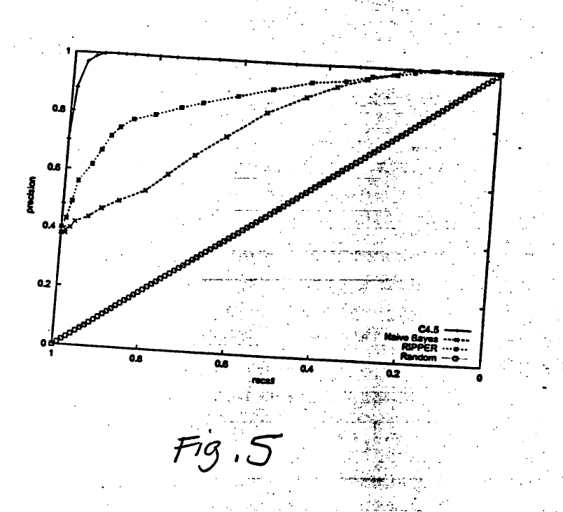

Using a mobile adhoct network simulator, the results to detect the anomaly status using cross-feature analysis on top of three different base classifiers are show in a ROC curve (or Receive Operation Characteristics) as shown in FIG. 5. Recall is a measure of the fraction of known positive examples that are correctly classified. Precision is a measure of the fraction of the classified positive examples that are truly positive. If I denotes intrusions and A denotes alarms (i.e., classified as positive), then recall rate isp(A|I)and the precision rate isp(I|A). The better (higher) a recall rate is, the more abnormal instances are captured. The better (higher) a precision rate is, the more chance that alarms are really intrusions. It is hard to achieve perfect results for both measures at the same time in practice. Some trade-off has to be made based on other criteria. In a ROC curve, the x-axis is the recall rate and the y-axis is the precision rate. The x-axis is drawn from 1 to 0 so that the theoretically optimal point ( i.e., both values of recall and precision are 1.0) appears in the top left corner. Obtaining various operation points in the recall-precision space by varying decision thresholds is achieved during such experiments. A larger (smaller) threshold implies more (less) examples are classified as positive, then the recall rate may go up (down) since more (less) anomalies have chance to be classified correctly. On the other hand, the precision rate may go down (up) since more (less) normal events are also classified as alarms. The 45-degree diagonal of the recall-precision curve is the result of random guess”, where anomalies and normal con anomalies. The closer the curve follows the left border and then the top border, the more accurate a proposed method is. In practice, recall and precision carry different costs. The choice of decision threshold is to minimize the total loss.

The recall-precision curves with three classifiers (C4.5, RIPPER and NBC) are shown in FIG. 5 based on average probability measures. The results from the three classifiers are quite different. Quantitatively, by using the area between a curve and the “random guess” diagonal line, or AUC (Area Under the Curve), to evaluate the accuracy degree of the corresponding classifier are shown. Using the measure, C4.5 shows almost perfect performance as its curve is very close to the left and top borders, which is far much better than those of the other two classifiers.

This invention provides an automatic and non ad hoc approach for anomaly detection that is applicable to a wide range of inductive learners such as decision trees, rule learners as well as naïve Bayes, among others. The inventive cross-feature analysis is applicable to self-diagnosis, anomaly detection, outlier detection, and skewed distribution data mining. In self-diagnosis, the training data for cross-feature analysis is the normal state of the target system. Cross-feature analysis computes inter-feature models to capture the inter-feature relationships of the normal state. When an abnormal state happens, the inter-feature model will capture their differences from normal state and report the problem to the user of the system. In anomaly detection, known activities of a target system are used as the training data for cross-feature analysis. The invention will capture the important relationships among known states. When an unknown state takes places, its deviation from normal state will be caught by cross-feature analysis. Outlier detection detects statistically erroneous data points from a collection of data samples. Cross-feature analysis can compute the relationships among sampled data points. A data point is considered an outlier if its cumulative distance is greater than a threshold. Skewed distribution data mining refers to the problem that for some applications, the rate of positive examples may be extremely low. Any existing inductive learners will regard positive examples as noise and will not be able to compute any model. Cross-feature analysis does not require either positive or negative class labels. Therefore, it provides a natural and easy solution for skewed data mining.

With conventional anomaly detection systems that use machine learning, a data entry is regarded as an anomaly if it does not fall into any of the previously segregated spaces for normal data. The invention is superior to such systems and takes advantage of inter-feature correlation and predicts the value of one feature using values of other features. Further, the invention is superior to such systems because the invention computes a cumulative distance and uses a threshold to predict anomalies. The invention's cross-feature analysis is very straightforward and easy to implement.

While the invention has been described in terms of preferred embodiments, those skilled in the art will recognize that the invention can be practiced with modification within the spirit and scope of the appended claims.

1. A method of automatically identifying anomalous situations during system operations, said method comprising:
recording actions performed by said system as features in a history file;
automatically creating a model for each feature only from normal data in said history file;
performing training by calculating anomaly scores of said features;
establishing a threshold to evaluate whether features are abnormal;
automatically identifying abnormal actions of said system based on said anomaly scores and said threshold; and
periodically repeating said training process.

2. The method in claim 1, wherein said process of creating a model for each feature comprises:
establishing relationships that exist between said features for normal system operations;
selecting a labeled feature from said features;
mathematically rearranging said relationships from the point of view of said labeled feature to create a solution for said labeled feature, wherein said solution comprises a model for said labeled feature;
selecting different features as said labeled feature and repeating said process of mathematically rearranging said relationships to produce solutions from the point of view of each remaining feature as models for the remaining features.

3. The method in claim 2, wherein said solution comprises a mathematical statement of what said labeled feature equals in terms of the relationships between the remaining features.

4. The method in claim 2, wherein said normal system operations comprise said features in said history file at the time said models are created.

5. The method in claim 1, wherein said training comprises:
predicting the likelihood that each feature will be normal when one or more of the other features are abnormal, using said model of each of said features;
repeating said predicting using different presumptions about other features being normal and abnormal to produce a trained file of a plurality of anomaly scores for each of said features.

6. The method in claim 5, wherein said trained file provides an normally score for each of said features for each of a plurality of different possible abnormalities.

7. The method in claim 5, wherein said process of identifying abnormal actions comprises:
determining values of said features for a given operation of said system;
referring to said trained file to retrieve and anomaly score for each of said features;
comparing said anomaly score for each of said features with said threshold to determine whether each anomaly score exceeds said threshold.

8. A method of automatically identifying anomalous situations during system operations, said method comprising:
recording actions performed by said system as features in a history file;
automatically creating a model for each feature only from normal data in said history file;
performing training by calculating anomaly scores of said features;
establishing a threshold to evaluate whether features are abnormal;
automatically identifying abnormal actions of said system based on said anomaly scores and said threshold; and
periodically repeating said training process,
wherein said process of creating a model for each feature comprises:
establishing relationships that exist between said features for normal system operations;
selecting a labeled feature from said features;
mathematically rearranging said relationships from the point of view of said labeled feature to create a solution for said labeled feature, wherein said solution comprises a model for said labeled feature;
selecting different features as said labeled feature and repeating said process of mathematically rearranging said relationships to produce solutions from the point of view of each remaining feature as models for the remaining features.

9. The method in claim 8, wherein said solution comprises a mathematical statement of what said labeled feature equals in terms of the relationships between the remaining features.

10. The method in claim 8, wherein said normal system operations comprise said features in said history file at the time said models are created.

11. The method in claim 8, wherein said training comprises:
predicting the likelihood that each feature will be normal when one or more of the other features are abnormal, using said model of each of said features;
repeating said predicting using different presumptions about other features being normal and abnormal to produce a trained file of a plurality of anomaly scores for each of said features.

12. The method in claim 1 1, wherein said trained file provides an normally score for each of said features for each of a plurality of different possible abnormalities.

13. The method in claim 11, wherein said process of identifying abnormal actions comprises:
determining values of said features for a given operation of said system;
referring to said trained file to retrieve and anomaly score for each of said features;
comparing said anomaly score for each of said features with said threshold to determine whether each anomaly score exceeds said threshold.

14. A method of automatically identifying anomalous situations during system operations, said method comprising:
recording actions performed by said system as features in a history file;
automatically creating a model for each feature only from normal data in said history file;
performing training by calculating anomaly scores of said features;
establishing a threshold to evaluate whether features are abnormal;
automatically identifying abnormal actions of said system based on said anomaly scores and said threshold; and
periodically repeating said training process,
wherein said training comprises:
predicting the likelihood that each feature will be normal when one or more of the other features are abnormal, using said model of each of said features;
repeating said predicting using different presumptions about other features being normal and abnormal to produce a trained file of a plurality of anomaly scores for each of said features.

15. The method in claim 14, wherein said process of creating a model for each feature comprises:
establishing relationships that exist between said features for normal system operations;
selecting a labeled feature from said features;
mathematically rearranging said relationships from the point of view of said labeled feature to create a solution for said labeled feature, wherein said solution comprises a model for said labeled feature;
selecting different features as said labeled feature and repeating said process of mathematically rearranging said relationships to produce solutions from the point of view of each remaining feature as models for the remaining features.

16. The method in claim 15, wherein said solution comprises a mathematical statement of what said labeled feature equals in terms of the relationships between the remaining features.

17. The method in claim 15, wherein said normal system operations comprise said features in said history file at the time said models are created.

18. The method in claim 14, wherein said trained file provides a normally score for each of said features for each of a plurality of different possible abnormalities.

19. The method in claim 14, wherein said process of identifying abnormal actions comprises:
determining values of said features for a given operation of said system;
referring to said trained file to retrieve and anomaly score for each of said features;
comparing said anomaly score for each of said features with said threshold to determine whether each anomaly score exceeds said threshold.

20. A program storage device readable by machine, tangibly embodying a program of instructions executable by the machine to perform a method of automatically identifying anomalous situations during system operations, said method comprising:
recording actions performed by said system as features in a history file;
automatically creating a model for each feature only from normal data in said history file;
performing training by calculating anomaly scores of said features;
establishing a threshold to evaluate whether features are abnormal;
automatically identifying abnormal actions of said system based on said anomaly scores and said threshold; and
periodically repeating said training process.

21. The program storage device in claim 20, wherein said method further comprises a process of creating a model for each feature comprises:
establishing relationships that exist between said features for normal system operations;
selecting a labeled feature from said features;
mathematically rearranging said relationships from the point of view of said labeled feature to create a solution for said labeled feature, wherein said solution comprises a model for said labeled feature;
selecting different features as said labeled feature and repeating said process of mathematically rearranging said relationships to produce solutions from the point of view of each remaining feature as models for the remaining features.

22. The program storage device in claim 21, wherein said method further comprises a mathematical statement of what said labeled feature equals in terms of the relationships between the remaining features.

23. The program storage device in claim 21, wherein said normal system operations comprise said features in said history file at the time said models are created.

24. The program storage device in claim 20, wherein said training method further comprises:
predicting the likelihood that each feature will be normal when one or more of the other features are abnormal, using said model of each of said features;
repeating said predicting using different presumptions about other features being normal and abnormal to produce a trained file of a plurality of anomaly scores for each of said features.

25. The program storage device in claim 24, wherein said trained file provides an normally score for each of said features for each of a plurality of different possible abnormalities.

26. The program storage device in claim 24, wherein said process of identifying abnormal actions further comprises:
determining values of said features for a given operation of said system;
referring to said trained file to retrieve and anomaly score for each of said features;
comparing said anomaly score for each of said features with said threshold to determine whether each anomaly score exceeds said threshold.
